(19) United States
(12) Patent Application Publication
(10) Pub. No.: US 2007/0174559 A1
(43) Pub. Date: Jul. 26, 2007

(54) Control system and method

(76) Inventors: Thomas Robert Pfingsten, Winona, MN (US); Stanton Hopkins Breitlow, Winona, MN (US)

Correspondence Address: HARNESS, DICKEY, & PIERCE, P.L.C, 7700 BONHOMME, STE 400, ST. LOUIS, MO, 63105, US

(21) Appl. No.: 11/653,466

(22) Filed: Jan. 12, 2007

Related U.S. Application Data
(60) Provisional application No. 60/761,307, filed on Jan. 23, 2006.

(51) Int. Cl. G06F 13/00

(52) U.S. Cl. 711/154

(57) ABSTRACT

A control system and method includes a controller operations system and a controller having hierarchically organized controller data. The controller operations system is configured for requesting first level controller data from a controller and receiving first level controller data from the controller, and requesting second level controller data from the controller in response to the received first level controller data, the requested second level controller data being associated with a particular received first level controller data. The controller is configured for receiving the request for first level controller data, transmitting first level controller data in response to the received request, receiving the request for second level controller data, and transmitting second level controller data in response to receiving the requesting for second level controller data.

### FIELD OF THE INVENTION

The present disclosure relates to control systems and methods, in particular to systems and methods for operating a control system having a controller and a control operations system.

### BACKGROUND

The statements in this section merely provide background information related to the present disclosure and may not constitute prior art.

Operational control systems including user interfaces often remotely monitor and/or manage power control systems used in an operational environment such as a manufacturing or process facility. An operational control system connects to the controllers it manages over communications links that often include both premises-based communications infrastructure (e.g., standard Local Area Networks, proprietary communications protocol links, wireless communications links, etc.) and inter-premises communications links that may include leased facilities and/or private networks. These remote systems typically include controller application software that is programmed and configured to manage communicatively coupled power controllers. Functions supported by the application software typically include controller and control device configuration, data logging and data monitoring.

The remote systems often include the receiving and displaying of power control system information associated with one or more coupled controllers. This typically requires that the remote system be configured with appropriate and compatible software for displaying, configuring and managing the controllers. Such preloaded software and data often includes control system architecture configuration data, individual controller configuration data, and associated control device data for each controller managed and supervised by the remote system. The compatible software in the remote software can be configured for retrieving controller information and data from the various coupled controllers, but typically requires prior knowledge of the type and characteristics of the controller in order to obtain the controller information and data. Each of these are often not only unique to the controller manufacturer, but also to each product line, and version or implementation of the product. This requires that the remote system and software include a variety of controller templates and for the software to be updated when new controller software, configurations, or parameters are updated, added or coupled to the remote system. Additionally, such operational control software requires that the software be upgraded and often reprogrammed to evolve with coupling of new products, with product innovations, and with product revisions.

### SUMMARY

The inventors hereof have succeeded at designing an operational control system and methods that are capable of accessing and displaying controller information without requiring prior knowledge of the controller's characteristics. As recognized by the inventors hereof, current operational systems and methods do not provide efficient and effective systems and methods that adapt to accessing and displaying information within an environment of changing control device configurations and newer products deployed within an operational production process. As such, the inventors have designed a system and method that enables a deployed operational control system to manage one or more controllers without having prior knowledge of characteristics or data in a controller in order to properly monitor and manage the controller and its associated controlled devices. The inventors have designed a system that enables an operational control system to automatically discover the architecture of a control system and the data structures of each controller and the associated devices it controls.

According to one aspect of the disclosure, a control system has a controller operations system and a controller having hierarchically organized controller data. The controller operations system is configured for requesting first level controller data from a controller and receiving first level controller data from the controller, and requesting second level controller data from the controller in response to the received first level controller data, the requested second level controller data being associated with a particular received first level controller data. Also included is a controller configured for receiving the request for first level controller data, transmitting first level controller data in response to the received request, receiving the request for second level controller data, and transmitting second level controller data in response to receiving the requesting for second level controller data.

According to another aspect of the disclosure, a controller having a processor, memory, and a communication interface for communicating over a communication link, has hierarchically organized controller data including first level controller data and second level controller data, wherein the second level controller data is associated with the first level controller data. The processor, the memory, and the communication interface are configured for receiving a request for first level controller data, transmitting first level controller data in response to the received request, receiving a request for second level controller data, and transmitting second level controller data in response to receiving the request for second level controller data.

According to another aspect of the disclosure, a controller operations system having a processor, a communication interface for communicating over a communication link, and memory, has a controller data discovery module configured for discovering hierarchically organized controller data from a controller communicatively coupled to the communication link. The processor, communication interface, and memory are configured for requesting first level controller data from the controller and receiving first level controller data, and requesting second level controller data from the controller in response to the received first level controller data, the requested second level controller data being associated with a particular received first level controller data.

According to still another aspect of the disclosure, a control system has a controller operations system and a controller with hierarchically organized controller data. The controller operations system includes a processor, a communication interface for communicating over a communication link, a memory, and a controller data discovery module. The controller data discovery module is configured for discovering hierarchically organized controller data from an associated controller, wherein the processor, communication interface, and memory are configured for requesting first level controller data from a controller and receiving first level controller data from the controller, and requesting second level controller data from the controller in response to the received first level controller data, the requested second level controller data being associated with a particular received first level controller data. The controller includes a processor, a memory including hierarchically organized controller data, a communication interface for communicating over the communication link. The processor, the memory, and the communication interface are configured for receiving the request for first level controller data, transmitting first level controller data in response to the received request, receiving the request for second level controller data, and transmitting second level controller data in response to receiving the requesting for second level controller data.

According to still another aspect of the disclosure, a method of operating a control system having an operations module and a controller with a processor, a memory, and hierarchically organized controller data. The method includes requesting first level controller data from the controller, transmitting the first level controller data from the controller in response to the requesting of first level controller data. The method also includes receiving the first level controller data at the operations module and requesting second level controller data from the controller in response to receiving the first level controller data, wherein the requested second level controller data is associated with a particular received first level controller data. The method further includes transmitting second level controller data from the controller in response to the requesting of the second level controller data.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments of the disclosure, are intended for purposes of illustration only and should not be construed as limiting the scope of the disclosure.

### BRIEF DESCRIPTION OF THE DRAWINGS

FIG. 1 is a block diagram of an automatic discovery power control system according to one exemplary embodiment of the disclosure.

FIG. 2 is a flow chart illustrating a method of operating a control system having a controller and an operations system for automatically discovering controller information organized in a hierarchical manner according to another exemplary embodiment of the disclosure.

FIG. 3 is a flow chart illustrating a sequence of procedures in an operational control system and method for accessing data in a controller according to one exemplary embodiment of the disclosure.

FIG. 4 is a flow chart illustrating a sequence of procedures in an operational control system and method for accessing information relating to the display of received controller data according to one exemplary embodiment of the disclosure.

FIG. 5 is a block diagram of a computer system that may be used to implement a method and apparatus embodying some aspects of one exemplary embodiment of the disclosure.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses. The present disclosure is described with respect to a power controller. However, other types of controllers may benefit from the teachings herein.

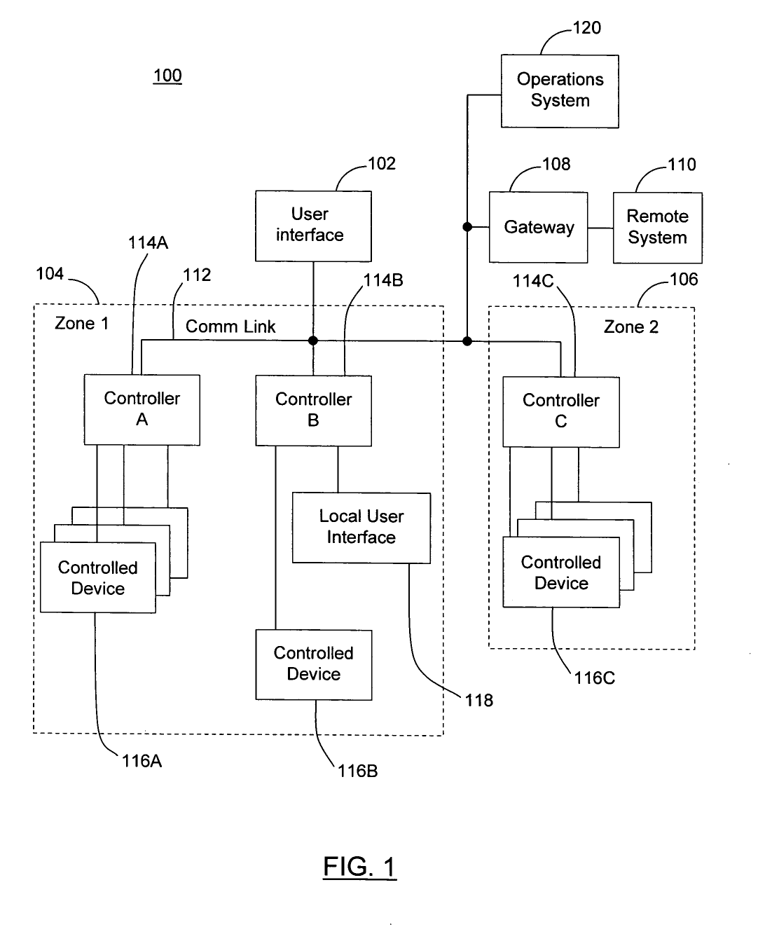

Referring to FIG. 1, an exemplary control system 100 is illustrated having two zones, zone 1—104 and zone 2—106 of control with three controllers 114A, 114B, 114C sharing a communications link 112. A local user interface 102 is configured with communication protocol to communicate to each controller 114A, 114B, 114C via the shared local communications link 112. The user interface can be local or remote to the controller and can include a display and or one or more user input mechanisms such as keys, buttons, touch pad, data interface, and voice input, by way of example.

The control system 100 can be any control system providing, at least in part, power to one or more operational systems in an operating or processing environment. This can include, by way of example, a control system for a factory, a machine, a process, a device, by way of example. Examples of controlled devices 116A-C can include any type of process or system such as a heater, a sensor, a flow meter, a motor, an actuator, or a valve, by way of example.

It should be understood that in some embodiments fewer or greater number of zones and/or controllers can be implemented within the power control system 100 and still be within the scope of the disclosure. Each controller is configured with a communication interface (not shown). Controllers 114A and 114B reside in an application defined zone 1 and controller 114C resides in an application defined zone 2. As shown, controller A controls a plurality of control devices 116A. Controller 114B is configured to control a single control device 116B and includes a local user interface 118 to facilitate local user interaction with controller 114B. This can include turning the controller 114B on and off, starting a control routine or profile, displaying a current setting, entering or setting a controller mode or parameter, by way of example. Controller 114C supervises, manages and/or provides power to a plurality of associated controlled devices 116C.

A gateway 108 is coupled or integrated with the shared communication link 112 and thereby in communication with controllers 114A-C. The gateway 108 can provide interfacing to the communication link 112 and therefore to one or more of the controllers 114A-C by a remote system or remote user interface. For example, FIG. 1 illustrates, by way of example, a remote operational system 110 that interfaces with or through the gateway 108. The remote operational system 110 can monitor one more controller or functions or operations thereof, log data from the controllers 114A-C, provide administration to one or more controllers 114A-C and/or control one or more controllers 114A-C of the power control system 100.

In other embodiments, an operations system 120 can be communicatively coupled to the communication link 112 for directly communication to the user interface 102, the gateway 108, and/or one or more controllers 114A-C. It should be understood that any of the system 100 components, as described herein, may be physically adjacent to one or more other components, or may be positioned at a distance from one another. An operations system 120 may also be incorporated into various components such as the user interface 102, the gateway 108, and/or the remote system. Each of the user interface 102, the gateway 108, or controllers 114A-C may each include an integral operation system. This has not been illustrated for simplicity.

One or more of the controllers 114A-C includes a processor, memory, and a communication interface for communicating over a communication link, and hierarchically organized controller data including first level controller data and second level controller data, wherein the second level controller data is associated the first level controller data. These data are as described throughout this disclosure. In the controller, the processor, the memory, and the communication interface are configured for receiving a request for first level controller data, transmitting first level controller data in response to the received request, receiving a request for second level controller data, and transmitting second level controller data in response to receiving the requesting for second level controller data. It should be noted, that some or all of the hierarchically organized controller data can be data about the data within the controller, e.g., controller metadata.

The controller can also be configured for receiving a request for third level data, and transmitting third level controller data in response to receiving the request for the third level controller data, wherein the transmitted third level controller data is associated with a particular first level controller data and a particular second level controller data. Often, the third level controller data includes a member associated with a particular class and instance of the hierarchically organized controller data.

In some embodiments, the controller is configured for receiving a request for fourth level controller data and transmitting fourth level controller data in response to receiving the request for fourth level controller data, wherein the transmitted fourth level controller data is associated with a particular received first level controller data, a particular second level controller data and a particular third level controller data. In some cases, the fourth level controller data includes an attribute associated with a particular class, instance, and member of the hierarchically organized controller data.

In some embodiments, the controller can include one or more power control mechanisms for selectively providing power to a controlled device. For example, the controller can include a switch, an actuator, a contactor, a mechanical relay, an optical relay, and a solid state relay, either within a unitary package or in association with the controller.

As noted above, the control system can include an operations system communicatively coupled to one or more controllers and configured to automatically discover the data structure and data of each controller. For example, a power controller operations system can include a processor, a communication interface for communicating over a communication link, and memory. Also a controller data discovery module can be configured for discovering hierarchically organized controller data from a controller communicatively coupled to the communication link. The controller data discovery module can include or be defined by computer executable instructions defining a thin client configured for discovering the hierarchically organized controller data.

The operations system can be configured to request first level controller data from one or more controllers and receive first level controller data from the controllers. Additionally, it can be configured to request second level controller data from a particular controller in response to the received first level controller data from that controller. The requested second level controller data is associated with the hierarchical organized data of the controller and therefore with a particular received first level controller data.

The operations system can include any type or function of operational, administrative or control system and can include a data logger, a database, a diagnostic system, a maintenance system, a personal computer, an administration system, and a processing system, by way of example.

The operations system can include a display configured for displaying the controller data. In this regard, in some embodiments, the hierarchically organized controller data includes controller display data. For example, the first level controller data can include pages available for displaying controller data and the second level controller data can include menus, instances and elements, by way of example. The display can be configured for displaying on the display the controller display data as a function of the received first and second level controller data.

The operations system can also include a user input mechanism for receiving an input from a user. As noted above, this can be a wide range of different mechanisms for receiving user inputs. In some embodiments, the operations system (such as the processor, communication interface, and memory) can be configured for requesting first level, second level, third level or fourth level controller data in response to receiving the user input.

In some embodiments, the operations system can include one or more application programs defined by computer executable instructions. In such embodiments, the operations system can be configured to request any level of controller data, for example, first level, second level, third level, or fourth level (where available) controller data in response to receiving an instruction from the application program for the controller data.

In some embodiments, the operations system can be configured to receive the second level controller data, request third level controller data from the controller in response to receiving the second level controller data. In some embodiments, the requested third level controller data is associated with a particular received first level controller data and a particular second level controller data.

In some other embodiments, the operations system can be configured to receive the third level controller data, and request fourth level controller data from the controller in response to receiving the third level controller data. The requested fourth level controller data can be associated with a particular received first level controller data, a particular second level controller data and a particular third level controller data. The operations system can also be configured for receiving the fourth level controller data from the controller.

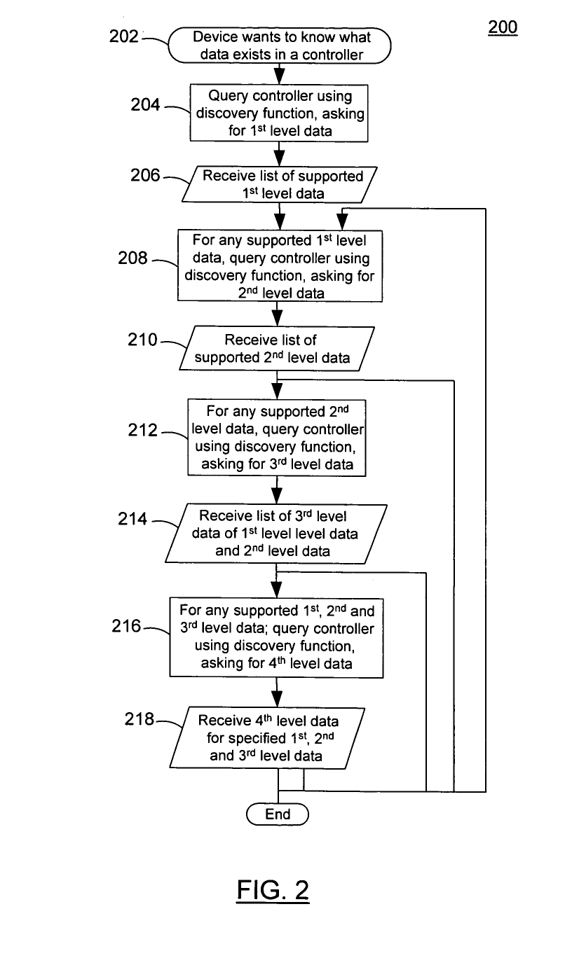

One exemplary operation of a control system according to this disclosure is illustrated in the flow chart of FIG. 2. The process flow 200 illustrates exemplary processes for managing a control system having one or more controllers and a control or operations system in communication therewith. This includes an automatic discovery method using hierarchically organized data contained within memory of the controller. Generally, the hierarchically organized data can include two or more levels of data. In this example, there are four levels of data, each higher level being built and associated with a lower level of data, and thereby providing further specification of the controller. In this example, first level data is the broadest or highest level of data, second level data identifies the number of occurrences of each of the instances of the first level data. The third level data identifies subcomponents of each occurrence of each first level data. These can often include parameters, characteristics, and values for each instance of each first level data.

Beginning with step 202, an operations device or system initiates a polling procedure or request to query the controller coupled thereto. The operations device queries the controller in process 204 requesting the number of first level data within its control domain. In process 206, the controller responds with a list of supported first level data. In process 208, the device queries the controller requesting second level data associated with a particular first level data. In process 210, the device receives the second level data for the requested first level data. In process 212, for one or more first level and/or second level data, the device queries the controller using the discovery function, requesting third level data. The device receives the third level data from the controller for one or more second level and first level data, as requested and/or supported in process 214. In process 216, for one or more provided first level data, second level data, and third level data class, instance and member, the device queries the controller using the discover function, requesting fourth level data. In process 218, the device receives the fourth level data associated with one or more of the requested fourth level data and as associated with one or more first level data, second level data and/or third level data. Processes 216-218 can be repeated for additional third level data, processes 212 to 218 can be repeated for additional second level data, and processes 208 to 218 can be repeated for additional first level data. Upon completion of method 200, the device or operational system may have executed some or all of the automatic discovery of the power control system architecture and data. The operation system can thereafter prepare a profile for each controller within the control system including all required controller data.

In one exemplary operation of the disclosure, a method of operating a controller system having an operations module and a controller with a processor, a memory, and hierarchically organized controller data includes requesting first level controller data from the controller, transmitting the first level controller data from the controller in response to the requesting of first level controller data, receiving the first level controller data at the operations module, requesting second level controller data from the controller in response to receiving the first level controller data, wherein the requested second level controller data is associated with a particular received first level controller data; and transmitting second level controller data from the controller in response to the requesting of the second level controller data.

In some embodiments, the method can also include displaying at the operations module the hierarchical organized controller displays as a function of the received first and second level controller data. In yet other embodiments, the method can include receiving an input from a user or process, wherein requesting the second level controller data is in response to the receiving of the input.

In some embodiment, the method can include receiving an input from a user or application process, wherein requesting the first, second, third or fourth level controller data is in response to the receiving of the input. For example, in some embodiments, a request for second, third or fourth level data may only be made when the data is required as a function of a user input, such as pushing a button or key, or as requested by a program. In this manner, the operations system does not have to request and store all of the controller data, and may only request that data that is necessary at the particular instant of time, or as required by one or more displays or application processes.

As discussed above, other embodiments can include receiving the second level controller data at the operations module, requesting third level controller data from the controller in response to receiving the second level controller data, wherein the requested third level controller data is associated with a particular received first level controller data and a particular second level controller data, and transmitting third level controller data from the controller in response to the requesting of the third level controller data. In other embodiments, one or more requests can be based on a schedule or timing, or event, such as a reboot, a reconfiguration, a scan, a coupling of a new component, or the upgrading of a controller.

In some embodiments, the method can include receiving the third level controller data at the operations module, requesting fourth level controller data from the controller in response to receiving the third level controller data, wherein the requested fourth level controller data is associated with a particular received first level controller data, a particular second level controller data and a particular third level controller data, and transmitting fourth level controller data from the controller in response to the requesting of the fourth level controller data.

In some embodiment, the method can also include configuring the operations system or module with a “thin client” controller application configured for requesting of the first and second level controller data. In this example, the controller thin client includes the discovery protocol and general hierarchical data request parameters for generating the data requests, storing the returned data, and determining the additionally required hierarchical data as may be required for the particular operation system and application. Generally, in the thin client embodiments, the operations system is not configured with pre-loaded data identifying or describing any of the controllers or other components. The thin client requests and stores the controller data for use by the operations system.

In other embodiments, the method includes configuring the data within the controller as hierarchically organized data and equipping the controller with an interface adapted for receiving the data requests from the operations system and transmitting the data requests in response to the received requests.

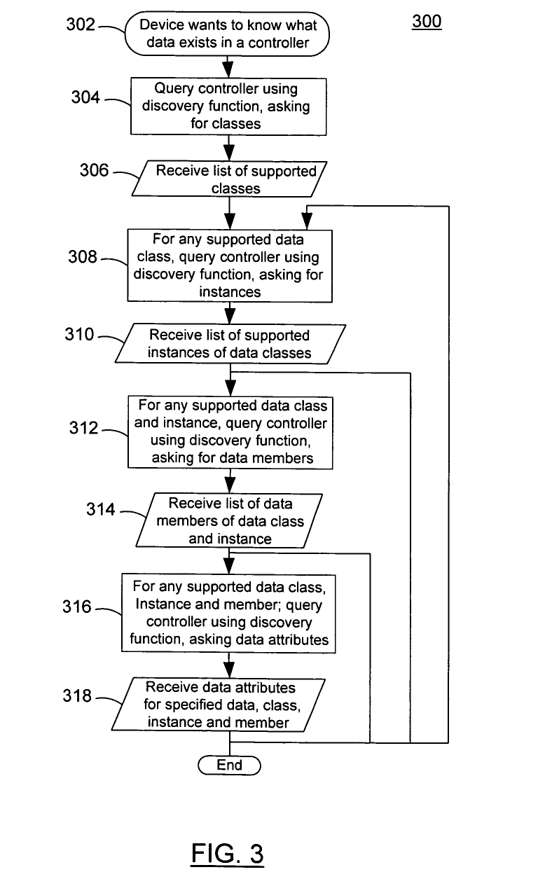

One exemplary operation of the control system 100 is illustrated in the flow chart of FIG. 3. Process flow 300 illustrates exemplary processes for an automatic discovery method using hierarchically organized metadata categories of classes, instances, members and attributes. In this example, a class is the highest level of metadata, instances are the number of occurrences of each class, members are a first subcomponent of each class, and attributes are data specific items such as parameters, characteristics, values, etc, that further define each data point as defined by a class, instance, and member. It is understood to those skilled in the art that one or more additional hierarchical levels can be implemented and/or fewer levels can be implemented and still be within the scope of the present disclosure. Additionally, while the terms metadata (typically defined as data about data), class, instance, member and attribute are used herein, data defined by different names or labels, consistent with the general teachings of this disclosure, are also within the scope of the present disclosure, and that such terms, are not intended to be limiting, but representative of one exemplary embodiment of the disclosure for discussion purposes.

Beginning with process 302, a device (remote system or local operational system) initiates a polling procedure to query the power controllers it supervises and manages. The device queries a controller in process 304 requesting the classes within its domain of control. In process 306 the controller responds with a list of supported data classes. In process 308, the device queries a controller requesting the instances (i.e., number of occurrences) of a particular class as provided by process 306. In process 310, the device receives a list of supported instances of the data class from the queried controller. In process 312, for each supported data class and instance as provided by the above processes, the device queries a controller using the discovery function, requesting its data members. The device receives a list of data members of the specified data class and the instance in process 314. In process 316, for each supported data class, instance and member, the device queries a controller using the discover function, requesting data attributes. In process 318, the device receives data attributes for the requested data class, instance and member from the controller. Processes 316-318 can be repeated for additional and sometimes each member, processes 312-318 can be repeated for additional and sometimes each instance, and processes 308-318 can be repeated for additional and sometimes each class. Upon completion of method 300, the device (operational system or remote system) has executed the complete automatic discovery of the power control system architecture and its components. If all processes are repeated for all classes, all instances of each class, all members, and all attributes, the device will have a complete operating profile of the controller, at least as complete as defined or enabled by the controller.

It should be noted that control system identification of first, second and third levels of data do not require that the data be predetermined. For example, when discovering what classes are supported by a controller, the controller may respond with a list of class identifiers which have no significance in value to any other device. The identifiers may simply be a set of numbers such as 1, 3, 4, 7 and 8, where 1 may mean the analog input class on a first controller. A second controller may respond with a similar number list such as 3, 4, 6, and 9, where 6 represents the analog input class internal to the second controller. The actual value of these identifiers is irrelevant because the thin client can query such items as the name of a class identifier number, for example, the name of the class in the first controller associate with “1”.

In some embodiments, the hierarchically organized data in a controller is uniquely referenced by its class, instance and member. A class is a group of related members. The instance is a specific grouping, when a plurality of similar groupings exists. A grouping is characterized by its related functionality. If the function disappears, the entire class disappears. If a new feature is added, at least one new class must be added. Exemplary class categories include, but are not limited to analog input class, PID (proportional, integral, derivative) class and product diagnostic class.

Table 1 illustrates each member name within the analog input class its read/write status, data format, valid values and units of measure. For the analog input class, instances relate to the number of physical analog inputs on the controller.

TABLE 1
Analog Input Class Member Data

| | Read/Write | | | Units of |
|---|---|---|---|---|
| Member Name | Status | Data Format | Valid Values | Measure |
| Measurement | R/W | Enumerated | Volts | N/A |
| Type | | List | Milliamps | |
| | | | Ohms | |
| Measured | Read Only | Float | −1000 to 1000 | Volts |
| Value | | | | |
| Measurement | Read Only | Enumerated | True | N/A |
| Fault | | List | False | |
| Max | R/W | Float | 0 to 1000 | Volts |
| Measurement | | | | |
| Scale | | | | |
| Min | R/W | Float | −1000 to 0 | Volts |
| Measurement | | | | |
| Scale | | | | |

These data members are collectively associated with a given instance of an analog input. Some of the data may be changed by PC software or remote system, while some parameters can only be read. For a member data element that can be changed, the table summarizes what values it will accept. Changing the measurement type from volts to ohms causes the units of measure attribute for other data members to change from volts to ohms. The PC software or remote system do not require a prior knowledge of that interaction. By reading the attributes and member values, the operational system or remote system has what it needs to correctly display, modify and/or log the data point.

Table 2 illustrates each member name within the PID class, its read/write status, data format, valid values and units of measure. Instances, in this class, relate to the number of simultaneous PID algorithms that exist within the controller.

TABLE 2
PID Class Member Data

| | Read/Write | | | Units of |
|---|---|---|---|---|
| Member Name | Status | Data Format | Valid Values | Measure |
| Set Point | R/W | Float | 0 to 1000 | ° C. |
| Proportional Gain | R/W | Float | −100.00 to 100.00 | Volts |
| Integral Time | R/W | Float | 0 to 600 | Seconds |
| Derivative Time | R/W | Float | 0 to 600 | Seconds |
| Output Power | Read Only | Float | 0 to 100 | Percent |
| Measurement Source | R/W | Enumerated List | Analog Input class | N/A |
| Class | | | PID class | |
| Measurement Source | R/W | Enumerated List | 1 | N/A |
| Instance | | | 2 | |
| | | | 4 | |
| Measurement Source | R/W | Enumerated List | Measured Value | N/A |
| Member | | | Output Power | |

The PID class is associated with an algorithm rather than a physical entity. It may have members which reference another class, allowing a remote system or operational system to change the PID measured value to come from analog input 4 rather than analog input 1, by way of example.

Table 3 illustrates each member name within the product diagnostic class, its read/write status, data format, valid values and units of measure. The diagnostic class consists of data points related to a diagnostic function. This, in many cases, be a single instance the diagnostic class typically applies to the entire controller.

TABLE 3
Product Diagnostic Class Member Data

| Member | Read/Write | | | Units of |
|---|---|---|---|---|
| Name | Status | Data Format | Valid Values | Measure |
| SSR Fault | Read only | Enumerated List | None | N/A |
| | | | Shorted | |
| | | | Open | |
| | | | Half-Waving | |
| Safety Limit | Read only | Enumerated List | None | N/A |
| Fault | | | Exceeded | |
| | | | High Limit | |
| | | | Exceeded | |
| | | | Low Limit | |
| Current Fault | Read only | Enumerated List | None | N/A |
| | | | Exceeded | |
| | | | High Current | |
| | | | Exceeded | |
| | | | Low Current | |
| Memory | Read only | Enumerated List | Passed | N/A |
| Test | | | Failed | |

Characteristics of “data,” are mostly predetermined, such as attributes. When a control system asks for attributes, it must know what attribute is being requested and how to interpret the response. Attributes can be generic in nature and apply to most data. Examples include a read/write capability, data representation, the number of significant digits, etc. A few attributes are not generic in nature, such as the name of the data. Some names my be common and can thus be agreed upon ahead of time. In such cases, a predetermined identifier for a name may be used. However, for names that are not predetermined, it would be possible to identify them as being not predetermined and provide a mechanism to read the name from the controller. The name could be in a universal format such an ASCII string, which could then be displayed directly on the thin client application.

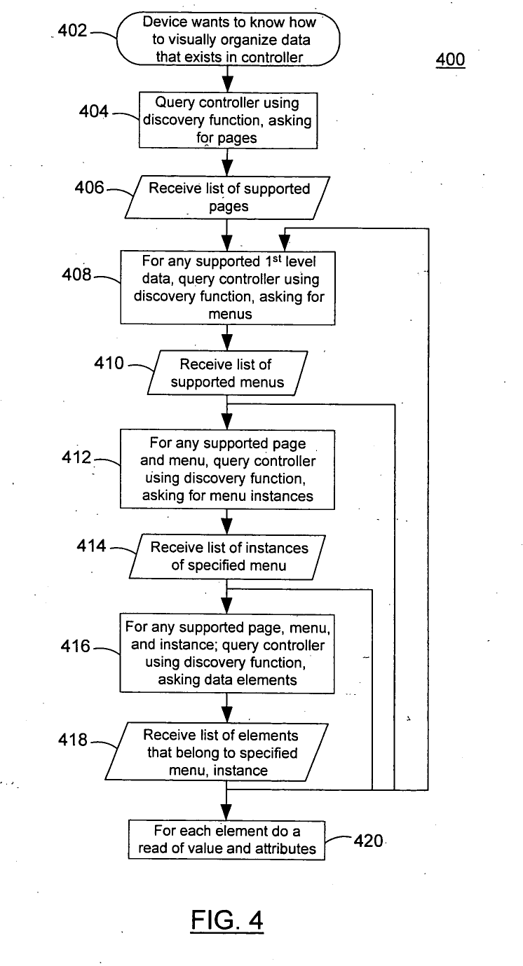

The flowchart of FIG. 4 depicts the processes within the automatic discovery method related to operational system/remote system receipt of information display parameters using the metadata categories of pages, menus, instances and elements. In process 402, the device (operational system/remote system) initiates a polling of controller information related to displaying information related to the control devices within the domain of a given controller. The device, in process 404, queries a controller using the discovery function, requesting metadata for page. In process 406, the controller responds with a list of supported pages. In process 408, a controller is next queried for menus associated with the supported page and the controller responds in process 410 with a list of supported menus. Next the device queries a controller, requesting the menu instances in process 412. The controller provides a list of instances of the specified menu to the device in process 414. After receiving the list of instances, the device asks for the data elements for any supported page, menu and instance in process 416. The device receives a list of elements from a controller in process 418 that belong to the specified page, menu and instance. Processes 416-418 can be repeated for each instance. Processes 412-418 can be repeated for each menu. Processes 408-418 can be repeated for each page supported by a controller. In process 420, a device reads a value and the attributes for each element. Subsequent to the complete execution of the method of FIG. 4, a remote system or operational system has all the information needed to properly display the received data.

Pages, menus and elements organize data based on how a user may associate the data, which may be the same or different as to how data is grouped by class, instance and member. Four metadata levels (pages, menus, instances, and elements) are illustrated by way of example; however, the method as illustrated is not limited to four levels.

Pages can define the top level of the hierarchy and exemplary pages include configuration, profile, operations and diagnostic. A controller may support one or more pages. Based upon a usability model, the page accessed by a user may vary. For example, a user would go to the configuration page when first using a controller or if there is a major change of product use. The diagnostic page would be accessed for troubleshooting purposes. The operational page would be accessed by the user for data relating to normal day to day usage of a controller. The operational system or remote system may use only select pages based upon its intended purpose. A troubleshooting tool may only access the diagnostic page. A data logger may only use an operations page. A remote system may use all supported pages.

The next level down from the pages level is the menu level and a page level may have one or more menus. Menus provide a further division or grouping of like data and include, for example but are not limited to, analog input parameters, PID parameters and alarm parameters. Instances can include the next level down from menus and define the number of instances for a menu. For example, there may be four analog input menus on the configuration page. Elements comprise the fourth level in the hierarchy and define individual data points. A menu is made up of one or more elements. An element references a data class, instance and member. Exemplary elements include but are not limited to, proportional gain, integral time, derivative time, SSR (solid state relay) fault, limit fault and measurement type.

Having defined the hierarchically organized controller data structures for the automatic discovery method of FIG. 3 associated with discovery of classes, instances, members, and attributes related to a controller and the method of FIG. 4 associated with pages, menus, instances, and elements, an exemplary controller data display structure can be developed. The exemplary controller data display structure can include, one or more display pages and in one embodiment it may include three display pages, a configuration display page, an operations display page, and a diagnostics display page, by way of example.

The configuration page can include one or more menus such as an analog input parameters menu and PID parameters menu, each with “n” instances, by way of example. The analog input menu can include one or more elements, such as the following elements, by way of example:

a) Analog input class, instance 1, measurement type

b) Analog input class, instance 1, maximum measurement scale

c) Analog input class, instance 1, minimum measurement scale

d) Analog input class, instance 2, measurement type

e) Analog input class, instance 2, maximum measurement scale

f) Analog input class, instance 2, minimum measurement scale

The PID menu can have a variety of elements, including one or more of the following elements, by way of example:

a) Proportional gain

b) Integral time

c) Derivative time

d) Measurement source class

e) Measurement source instance

f) Measurement source member

The operations page can have one or more menus and in some embodiments a single menu such as the identification of a zone. The zone menu can include a variety of elements, including the following elements, by way of example:

a) Analog input class, instance 1, measurement type

b) Analog input class, instance 1, measurement fault

c) PID class, instance 1, set point

d) PID class, instance 1, proportional gain

e) PID class, instance 1, integral time

f) PID class, instance 1, derivative time

g) Analog input class, instance 2, measurement type

h) Analog input class, instance 2, measurement fault

i) PID class, instance 2, set point

The diagnostics page can include a variety of menus. For example, it may include, an analog input menu and a system menu, by way of example. An analog input menu can include one or more elements. These can include the same number of instances “n” of analog input menus as there are analog input classes.

a) Analog input class, instance n, measurement fault

b) Analog input class, instance n, measured value

The system menu can include one or more elements, including the following elements, by way of example:

a) Diagnostic class, instance 1, SSR fault

b) Diagnostic class, instance 1, safety limit fault

c) Diagnostic class, instance 1, current fault

d) Diagnostic class, instance 1, memory test

Pages, menus, instances and elements can organize data based on either use scenarios or native feature orientation. A page and menu may reference any data item and a single data element may show up in multiple pages and menus. Not all data may be represented in a page and menu. By having the capability to present data in these two formats (use scenario, native feature orientation) an operational system or remote system can use data relevant to its application while relying on a controller to provide all of the content, including its context and presentation. A data logger may only require analog input classes and more specifically, the measured value and measurement fault members. A master controller may only require a diagnostic class to determine that all systems are operating acceptably.

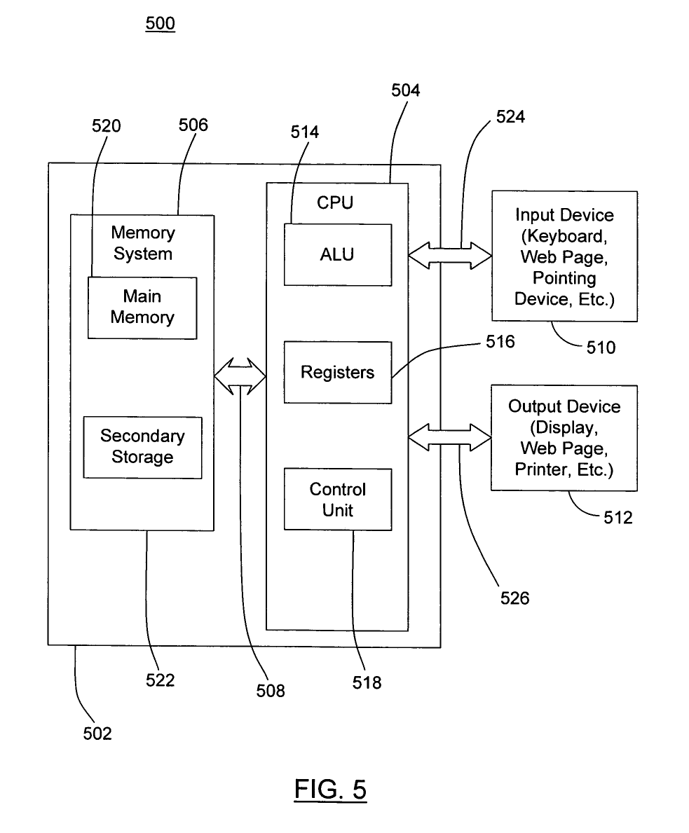

Referring now to FIG. 5, an operating environment for one or more illustrated embodiments of various components or modules as described above can include a computer or processing system 500 having a computer 502 that comprises at least one high speed processing unit (CPU) 504, in conjunction with a memory system 506 interconnected with at least one bus structure 508, an input device 510, and an output device 512. These elements are interconnected by at least one bus structure 512. Examples of power control systems having one or more of these exemplary operating environment components, can include the power controllers, the local and remote user interfaces, the gateway, the operations system, and the remote operational system, by way of example. The controllers 114A-C may be implemented as the computer 502.

The illustrated CPU 504 is of familiar design and includes an arithmetic logic unit (ALU) 514 for performing computations, a collection of registers 514 for temporary storage of data and instructions, and a control unit 516 for controlling operation of the system 500. Any of a variety of processor, including at least those from Digital Equipment, Sun, MIPS, Motorola/Freescale, NEC, Intel, Cyrix, AMD, HP, and Nexgen, is equally preferred for the CPU 504. The illustrated embodiment of the disclosure operates on an operating system designed to be portable to any of these processing platforms.

The memory system 506 generally includes high-speed main memory 520 in the form of a medium such as random access memory (RAM) and read only memory (ROM) semiconductor devices, and secondary storage 522 in the form of long term storage mediums such as floppy disks, hard disks, tape, CD-ROM, flash memory, etc. and other devices that store data using electrical, magnetic, optical or other recording media. The main memory 520 also can include video display memory for displaying images through a display device. Those skilled in the art will recognize that the memory system 506 can comprise a variety of alternative components having a variety of storage capacities.

The input device 510 and output device 512 are also familiar and can be implemented associated with the local and remote user interfaces as well as a controller, remote operational system and operations system, by way of example. The input device 510 can comprise a keyboard, a mouse, a physical transducer (e.g. a microphone), etc. and is interconnected to the computer 502 via an input interface 524. The output device 512 can comprise a display, a printer, a transducer (e.g. a speaker), etc, and be interconnected to the computer 502 via an output interface 526. Some devices, such as a network adapter or a modem, can be used as input and/or output devices.

As is familiar to those skilled in the art, the computer system 500 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 506. As known to those skilled in the art, some of the methods, processes, and/or functions described herein can be implemented as software and stored on various types of computer readable medium as computer executable instructions. In various embodiments of the power control system described by example herein, the controller can include a robust operating and application program having the computer executable instructions for controlling the controller and the controlled devices. Additionally, one or more of the local and remote user interfaces; operations system and remote operations system can include, among other application software programs with computer executable instructions, a thin client application for communicating and interactively operating with one or more controllers as described above by way of example.

In accordance with the practices of persons skilled in the art of computer programming, the present disclosure is described below with reference to symbolic representations of operations that are performed by the computer system 500. Such operations are sometimes referred to as being computer-executed. It will be appreciated that the operations which are symbolically represented include the manipulation by the CPU 504 of electrical signals representing data bits and the maintenance of data bits at memory locations in the memory system 506, as well as other processing of signals. The memory locations where data bits are maintained are physical locations that have particular electrical, magnetic, or optical properties corresponding to the data bits. The disclosure can be implemented in a program or programs, comprising a series of instructions stored on a computer-readable medium. The computer-readable medium can be any of the devices, or a combination of the devices, described above in connection with the memory system 506.

The system may also be used to discover all controllers on the communication link including newly connected controllers. This may be performed by pinging or listening for new devices to be connected.

It should be understood to those skilled in the art, that some embodiments of systems or components described herein may have more or fewer computer processing system components and still be within the scope of the present disclosure.

When describing elements or features of the present disclosure or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that any processes or steps described herein are not to be construed as necessarily requiring their performance in the particular order discussed or illustrated. It is also to be understood that additional or alternative processes or steps may be employed.

What is claimed is:

1. A method of operating a controller system having an operations module and a controller with a processor, a memory, and hierarchically organized controller data, the method comprising:
requesting first level controller data from the controller;
transmitting the first level controller data from the controller in response to the requesting of first level controller data;
receiving the first level controller data at the operations module;
requesting second level controller data from the controller in response to receiving the first level controller data, wherein the requested second level controller data is associated with a particular received first level controller data; and
transmitting second level controller data from the controller in response to the requesting of the second level controller data.

2. The method of claim 1 wherein the first level controller data includes classes of controller data available from the controller.

3. The method of claim 2 wherein the second level controller data includes the instances of each class of controller data within the controller.

4. The method of claim 2 wherein the classes of first level controller data include a class selected from the list of analog input class, program class, PID class, and product diagnostic class.

5. The method of claim 1 wherein the hierarchically organized controller data includes controller display data.

6. The method of claim 5 wherein the first level display data includes pages available for displaying controller data.

7. The method of claim 6 wherein the second level controller data is selected from the group consisting of menus, instances and elements.

8. The method of claim 5, further comprising displaying at the operations module the hierarchical organized controller displays as a function of the received first and second level controller data.

9. The method of claim 1 wherein the first level controller data defines, at least in part, a configuration of the controller.

10. The method of claim 1 wherein the first level controller data is metadata.

11. The method of claim 1 wherein the first level controller data includes pages of controller displays supported by the controller.

12. The method of claim 11 wherein the second level controller data includes menus associated with one or more of the controller display pages.

13. The method of claim 1, further comprising receiving an input from a user or process, wherein requesting the second level controller data is in response to the receiving of the input.

14. The method of claim 1, further comprising:
receiving the second level controller data at the operations module;
requesting third level controller data from the controller in response to receiving the second level controller data, wherein the requested third level controller data is associated with a particular received first level controller data and a particular second level controller data; and
transmitting third level controller data from the controller in response to the requesting of the third level controller data.

15. The method of claim 14, further comprising receiving an input from a user or process, wherein requesting the third level controller data is in response to the receiving of the input.

16. The method of claim 14 wherein the third level controller data includes a member associated with a particular class and instance of the hierarchically organized controller data.

17. The method of claim 14, further comprising:
receiving the third level controller data at the operations module;
requesting fourth level controller data from the controller in response to receiving the third level controller data, wherein the requested fourth level controller data is associated with a particular received first level controller data, a particular second level controller data and a particular third level controller data; and
transmitting fourth level controller data from the controller in response to the requesting of the fourth level controller data.

18. The method of claim 17, further comprising receiving the fourth level controller data from the controller.

19. The method of claim 17 wherein the fourth level controller data includes an attribute associated with a particular class, instance, and member of the hierarchically organized controller data.

20. The method of claim 17, further comprising receiving an input from a user or process, wherein requesting the fourth level controller data is in response to the receiving of the input.

21. The method of claim 1 wherein the hierarchically organized controller data includes one or more controller data selected from the group consisting of data classes, data instances, data members and data attributes.

22. The method of claim 1 wherein requesting the first level controller data and requesting the second level controller data are each formatted using a discovery request over a data communication link.

23. The method of claim 1 wherein the requesting the first level controller data from the controller is periodic.

24. The method of claim 1, further comprising communicatively coupling the controller to the operations module, wherein requesting the controller to provide controller data is a function of receiving a signal from the controller indicating the communicative coupling.

25. The method of claim 24, further comprising transmitting a controller identification following the communicative coupling, wherein requesting the controller to provide controller data is upon receipt of the identification by the operations module.

26. The method of claim 24, further comprising scanning a communication link for a communicative coupling of a controller, wherein requesting is a function of the scanning.

27. The method of claim 1 wherein the operations module is selected from the group consisting of a remote user interface, a local user interface, a data logger, a database, a diagnostic system, a maintenance system, a personal computer, an administration system, a second controller and a processing system.

28. The method of claim 1, further comprising configuring the controller with a thin client adapted for the requesting of the first and second level controller data.

29. The method of claim 1, further comprising configuring the controller data within the controller as hierarchically organized data and equipping the controller with an interface adapted for receiving the first and second level controller data requests from the operations module and transmitting the first and second level controller data requests.

30. A controller having a processor, memory, and a communication interface for communicating over a communication link, comprising:
hierarchically organized controller data including first level controller data and second level controller data, wherein the second level controller data is associated with the first level controller data, and
wherein the processor, the memory, and the communication interface are configured for receiving a request for first level controller data, transmitting first level controller data in response to the received request, receiving a request- for second level controller data, and transmitting second level controller data in response to receiving the request for second level controller data.

31. The controller of claim 30 wherein the first level controller data includes classes of controller data available from the controller and the second level controller data includes the instances of each class of controller data.

32. The controller of claim 31 wherein the classes of first level controller data include a class selected from the list of analog input class, program class, PID class, and product diagnostic class.

33. The controller of claim 30 wherein the hierarchically organized controller data includes controller display data.

34. The controller of claim 33 wherein the first level display data includes pages available for displaying controller data and wherein the second level controller data is selected from the group consisting of menus, instances and elements.

35. The controller of claim 30 wherein the first level controller data defines, at least in part, a configuration of the controller.

36. The controller of claim 30 wherein the first level controller data is metadata.

37. The controller of claim 30 wherein the first level controller data includes pages of controller displays supported by the controller, and wherein the second level controller data includes menus associated with one or more of the controller display pages.

38. The controller of claim 30 wherein the processor, the memory, and the communication interface are configured for receiving a request for third level data, and transmitting third level controller data in response to receiving the request for the third level controller data, wherein the transmitted third level controller data is associated with a particular first level controller data and a particular second level controller data.

39. The controller of claim 38 wherein the third level controller data includes a member associated with a particular class and instance of the hierarchically organized controller data.

40. The controller of claim 38 wherein the processor, the memory, and the communication interface are configured for receiving a request for fourth level controller data and transmitting fourth level controller data in response to receiving the request for fourth level controller data, wherein the transmitted fourth level controller data is associated with a particular received first level controller data, a particular second level controller data and a particular third level controller data.

41. The controller of claim 40 wherein the fourth level controller data includes an attribute associated with a particular class, instance, and member of the hierarchically organized controller data.

42. The controller of claim 30 wherein the hierarchically organized controller data includes one or more controller data selected from the group consisting of data classes, data instances, data members and data attributes.

43. The controller of claim 30, further comprising a power control mechanism for selectively providing power to a controlled device.

44. The controller of claim 43 wherein the power control mechanism is selected from the group consisting of a switch, a transistor, an actuator, a contactor, a mechanical relay, an optical relay, and a solid state relay.

45. The controller of claim 38 wherein the processor, the memory, and the communication interface are configured for automatically transmitting a controller identification following a coupling of the controller to the communication link.

46. A power controller operations system having a processor, a communication interface for communicating over a communication link, and memory, comprising:
a controller data discovery module configured for discovering hierarchically organized controller data from a controller communicatively coupled to the communication link;
wherein the processor, communication interface, and memory are configured for requesting first level controller data from the controller and receiving first level controller data, and requesting second level controller data from the controller in response to the received first level controller data, the requested second level controller data being associated with a particular received first level controller data.

47. The system of claim 46 wherein controller data discovery module includes computer executable instructions defining a thin client configured for discovering the hierarchically organized controller data.

48. The system of claim 46 wherein the first level controller data includes classes of controller data available from the controller and second level controller data includes instances of each class of controller data within the controller.

49. The system of claim 48 wherein the classes of first level controller data include a class selected from the list of analog input class, program class, PID class, and product diagnostic class.

50. The system of claim 46 wherein the hierarchically organized controller data includes controller display data.

51. The system of claim 50 wherein the first level display data includes pages available for displaying controller data and wherein the second level controller data is selected from the group consisting of menus, instances and elements.

52. The system of claim 50, further comprising a display wherein the system is configured for displaying on the display the controller display data as a function of the received first and second level controller data.

53. The system of claim 46, further comprising a user input mechanism for receiving an input from a user, wherein the processor, communication interface, and memory are configured for requesting at least one of the first level and second level controller data in response to receiving the user input.

54. The system of claim 46, further comprising an application program defined by computer executable instructions, wherein the processor, communication interface, and memory are configured for requesting at least one of the first level and second level controller data in response to receiving an instruction from the application program for the controller data.

55. The system of claim 46 wherein the processor, communication interface, and memory are configured for receiving the second level controller data, requesting third level controller data from the controller in response to receiving the second level controller data, wherein the requested third level controller data is associated with a particular received first level controller data and a particular second level controller data.

56. The system of claim 55, further comprising a user input mechanism for receiving an input from a user, wherein the processor, communication interface, and memory are configured for requesting the third level controller data in response to receiving the user input.

57. The system of claim 55, further comprising an application program defined by computer executable instructions, wherein the processor, communication interface, and memory are configured for requesting the third level controller data in response to receiving an instruction from the application program for the third level controller data.

58. The system of claim 55 wherein the processor, communication interface, and memory are configured for receiving the third level controller data, and requesting fourth level controller data from the controller in response to receiving the third level controller data, wherein the requested fourth level controller data is associated with a particular received first level controller data, a particular second level controller data and a particular third level controller data.

59. The system of claim 58 wherein the processor, communication interface, and memory are configured for receiving the fourth level controller data from the controller.

60. The system of claim 58 wherein the fourth level controller data includes an attribute associated with a particular class, instance, and member of the hierarchically organized controller data.

61. The system of claim 58, further comprising a user input mechanism for receiving an input from a user, wherein the processor, communication interface, and memory are configured for requesting the fourth level controller data in response to receiving the user input.

62. The system of claim 55, further comprising an application program defined by computer executable instructions, wherein the processor, communication interface, and memory are configured for requesting the fourth level controller data in response to receiving an instruction from the application program for the fourth level controller data.

63. The system of claim 46 wherein the processor, communication interface, and memory are configured for requesting the first level controller data and the second level controller data utilizing a common discovery request.

64. The system of claim 46, further comprising a system clock, wherein the requesting the first level controller data from the controller is periodic and determined as a function of the clock.

65. The system of claim 46 wherein the controller is configured for receiving a controller identification over the communication link and initiating at least one of the requests for controller data as a function of the received controller identification.

66. The system of claim 46 wherein the system is selected from the group consisting of a remote user interface, a local user interface, a data logger, a database, a diagnostic system, a maintenance system, a personal computer, an administration system, a second controller and a processing system.

67. A control system comprising:
a controller operations system having a processor, a communication interface for communicating over a communication link, a memory, and a controller data discovery module configured for discovering hierarchically organized controller data from an associated controller, wherein the processor, communication interface, and memory are configured for requesting first level controller data from a controller and receiving first level controller data from the controller, and requesting second level controller data from the controller in response to the received first level controller data, the requested second level controller data being associated with a particular received first level controller data; and
a controller having a processor, a memory including hierarchically organized controller data, a communication interface for communicating over the communication link, wherein the processor, the memory, and the communication interface are configured for receiving the request for first level controller data, transmitting first level controller data in response to the received request, receiving the request for second level controller data, and transmitting second level controller data in response to receiving the requesting for second level controller data.

68. The system of claim 67 wherein the controller operations system is selected from the group consisting of a remote user interface, a local user interface, a data logger, a database, a diagnostic system, a maintenance system, a personal computer, an administration system, a second controller and a processing system.

69. A power control system comprising:
a power controller operations system configured for requesting first level controller data from a controller and receiving first level controller data from the controller, and requesting second level controller data from the controller in response to the received first level controller data, the requested second level controller data being associated with a particular received first level controller data; and
a power controller having hierarchically organized controller data, the controller configured for receiving the request for first level controller data, transmitting first level controller data in response to the received request, receiving the request for second level controller data, and transmitting second level controller data in response to receiving the requesting for second level controller data.

70. The system of claim 69 wherein the power controller operations system is selected from the group consisting of a remote user interface, a local user interface, a data logger, a database, a diagnostic system, a maintenance system, a personal computer, an administration system, a second controller and a processing system.
